(19) United States
(12) Patent Application Publication
(10) Pub. No.: US 2010/0064803 A1
(43) Pub. Date: Mar. 18, 2010

(54) TECHNIQUES FOR DETERMINING A VELOCITY OF A SPORT OBJECT

(75) Inventors: Tomi Salmi, Vantaa (FI); Timo Salmi, Vantaa (FI); Lauri Ilvas, Vantaa (FI); Anssi Luomaranta, Espoo (FI); Miikka Tikander, Helsinki (FI)

Correspondence Address: BIRCH STEWART KOLASCH & BIRCH, PO BOX 747, FALLS CHURCH, VA, 22040-0747, US

(73) Assignee: Shoot the Balls Oy, Espoo (FI)

(21) Appl. No.: 12/367,762

(22) Filed: Feb. 9, 2009

(30) Foreign Application Priority Data
Sep. 17, 2008 (FI) 20085876

(51) Int. Cl. G01P 15/00; H04M 1/00

(52) U.S. Cl. 73/491; 455/556.1

(57) ABSTRACT

A method for determining a velocity of an object (O), such as a ball, over a span length (SL) extending from a span start (SS) to a span end (SE). An audio signal (AS) is received by a mobile telephone's (MT) microphone (MP). An approximate travel time (TT) for a traversal of the span length (SL) by the object (O) is determined, which act time comprises processing the audio signal (AS) and detecting a first shape (210) and a second shape (212) which respectively correspond to an approximate start time (T1) and approximate end time (T2) of the traversal, and determining the approximate travel time (TT) based on the detected first shape (210) and second shape (212). The object's velocity is determined based on the span length (SL) and approximate travel time (TT).

### RELATED APPLICATIONS

The present application claims priority from Finnish patent application number 20085876, filed 17 Sep. 2008.

### BACKGROUND OF THE INVENTION

The invention relates to techniques for determining velocity of a sport object. A representative but non-restrictive list of exemplary sport objects includes balls, pucks, arrows and comparable items.

In many games, the velocity of sport object is crucial to the athlete's performance, which is why athletes aim at improving the initial velocity, or start velocity, of the sport objects. It is customary to measure the initial velocity of sport object by means of Doppler radar. A problem with this approach is that the Doppler radar is prohibitively expensive to most amateur athletes. Accordingly, there is a need for simpler equipment for measuring the velocity of a sport object.

### BRIEF DESCRIPTION OF THE INVENTION

An object of the invention is to develop techniques for measuring the velocity of a sport object with a simpler and less costly equipment than in conventional methods. The object of the invention is achieved by a method, apparatus and software product as specified in the attached independent claims. The dependent claims as well as the present patent specification and drawing relate to specific embodiments and implementations of the invention.

The invention is partially based on the idea of determining the object's velocity by means of a mobile telephone. Mobile telephones are ubiquitous, sophisticated pieces of equipment, many of which support additional program modules which can be used to direct the mobile telephone's processor to perform the necessary processing acts and calculations. The invention is also based on the idea of using the mobile telephone's built-in microphone or some microphone operatively coupled to the mobile telephone to receive an audio signal based on which the start and end times of the sport object's movement can be detected. In addition, a span length traversed by the object is determined by the mobile telephone, by receiving this information from the mobile telephone's user interface, for example. The start and end time plus the span length suffice to provide an approximation for the object's average velocity.

Most athletes wish to know the object's initial (start) velocity, which can be estimated by applying some correction to the average velocity. Such a correction can be determined empirically, for example by performing a statistically sufficient number of experiments in which the object's average velocity is determined by dividing the span length traversed by the object by the travel time, while the object's initial velocity is determined with some other means, such as Doppler radar. Such a statistically sufficient number of experiments will yield an empirical correction by which the initial velocity can be determined on the basis of average velocity and span length. It is also possible to entirely bypass the determination of the average velocity and generate an empirically determined function or lookup table whose inputs are the span length and travel time and the output of the function or lookup table is the initial velocity.

Based on the preceding description of the invention alone, it would seem that the invention is merely based on performing simply physical calculations by a mobile telephone's processor. Those skilled in the art will realize, however, that implementing the invention requires solutions to several residual problems,

A first residual problem is the fact that in the application programming interface (API) of conventional mobile telephones, it is problematic to determine the time of an event with a resolution which is sufficient for accurate timing of the object's movement. For instance, the resolution of various timers varies between platforms and telephone models.

A second residual problem is the fact that most mobile telephones are not designed for accurate and objective measurement of sound. Nor are they designed for post-processing of measured sound within the mobile telephone. Instead, mobile telephones are designed to take audio samples called “codebook samples” of human speech and transfer the codebook samples via a traffic channel to a base station in a wireless radio network. For example, it is a well-known fact that the audio circuitry of a conventional mobile telephone and the voice coding algorithm of GSM telephones are incapable of reliably transmitting DTMF (dual-tone, multi-frequency) sounds, which is why various bypass techniques for conveying DTMF sounds have been developed. Some features and embodiments of the invention aim at solving these residual problems.

Provided that the mobile terminal's processor has sufficient processing power, the audio samples can be captured and processed as a real-time operation. Real-time processing does not have a universally adopted definition, but for the purposes of the present invention and its embodiment, real-time processing of audio samples means that the mobile terminal, including all hardware and firmware involved, such as the processor, system firmware, application programming interface and audio processing circuitry are capable of detecting the first and second shapes that indicate the start and end times of the object movement as fast as the audio samples are captured. Typical mobile terminals built on Symbian® platforms are capable of operating in this mode. A benefit of real-time operation is that there is no need to buffer the audio samples for a longer time that what is required for the detection of the first and second shapes. This means that the audio buffer can be re-used or re-filled in a circular fashion and the mobile terminal, under control of the inventive program module, can wait indefinitely for the first shape that indicates the start time of the object's movement. In other words, the mobile terminal can buffer audio samples only as much as is required for detecting either of the first and second shapes, and then discard the audio samples, for example by re-using the buffer memory area. As far as buffer memory consumption is concerned, the mobile terminal could wait indefinitely for the second shape, ie the one that indicates the end of the object's movement, but it is reasonable to utilize some sanity check which rejects the second shape if it occurs too long after the first shape.

In case the mobile terminal, including hardware and firmware resources, is incapable of real-time operation, an embodiment of the inventive program module may cause the mobile terminal to capture and buffer all the audio samples which include the first and second shapes, and any audio samples in between, prior to detecting the first and second shapes from among the buffered audio samples. A residual problem in such environments is that the captured audio samples must be buffered in a buffer memory, and the memory may be a scarce resource in low-power mobile terminals. The buffer memory requirements can be minimized by providing the user with a signal that indicates the time when the audio buffering begins. In some implementations, the signal can even set up to precede the beginning of audio buffering by a couple of seconds. This is useful in situations like a penalty kick in soccer, wherein the player may run for a couple of second before actually kicking the ball, which results in the first shape to be detected.

### BRIEF DESCRIPTION OF THE DRAWINGS

In the following the invention will be described in greater detail by means of specific embodiments with reference to the attached drawings, in which:

FIG. 1 shows some of the physical quantities involved;

FIG. 2 shows a representative sound profile received by a microphone during a velocity measurement and some related quantities;

FIG. 3 is block diagram of a representative mobile telephone;

FIG. 4 shows some of the data structures, parameters and variables in the memory of the mobile telephone according to an embodiment of the invention;

FIG. 5 shows an operating principle of the invention;

FIG. 6 is a flowchart which illustrates an embodiment specifically adapted for Symbian-based platforms; and

FIG. 7 is a flowchart which illustrates an embodiment specifically adapted for Java-based platforms.

### DETAILED DESCRIPTION OF SPECIFIC EMBODIMENTS

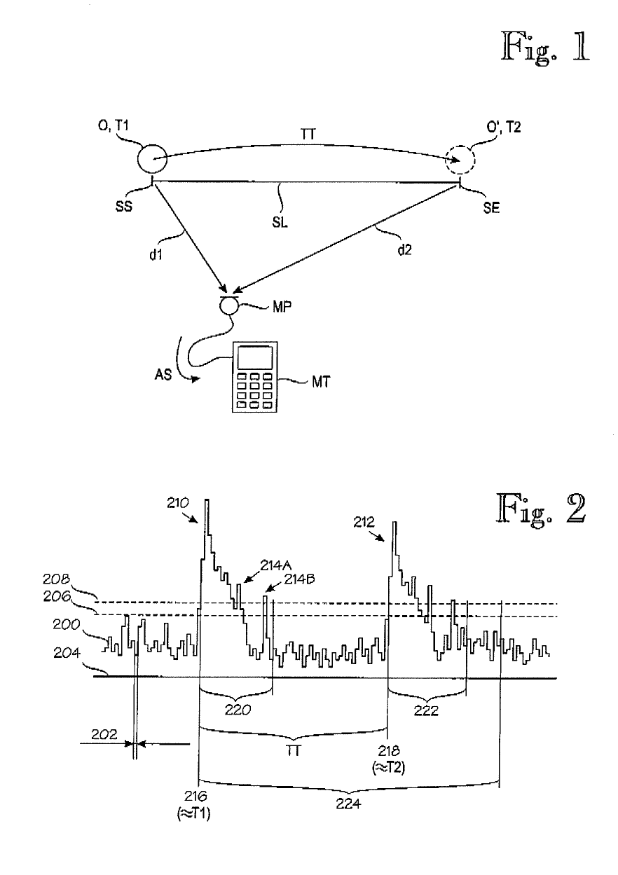

FIG. 1 illustrates some of the physical quantities involved. Reference sign O denotes a sport object, such as ball, puck, arrow or the like. During the velocity measurement the object O will traverse a span length SL from a span start SS to a span end SE. The object O is shown at the span start SS, while a dashed version O′ is shown at the span end SE. Reference signs T1 and T2 respectively denote the start and end times of the object's movement from the start position SS to the end position SE. The travel time TT for the object's traversal of the span length SL is determined with a microphone MP, which is operatively coupled to a mobile telephone MT. For example, the microphone MP can be the mobile telephone's built-in microphone or an external microphone coupled to the mobile telephone via a wired or wireless connection. A representative but non-restrictive example of a wireless microphone connection is a Bluetooth connection. Reference sign AS denotes the audio signal outputted by the microphone to the mobile telephone MT. The mobile telephone MT is capable of downloading and executing additional software modules.

The microphone MP is separated from the span start SS and span end by respective distances d1 and d2. If the difference d2−d1 is large and/or the typical velocity of the object is high, it is beneficial to divide d2−d1 by the speed of sound and subtract the quotient from the travel time (whose determination will be described in connection with FIG. 2). A benefit of using a microphone MP which is detached from the mobile telephone MT and coupled to it via a wired or wireless connection is that the microphone can be positioned at the center point of the span length SL or close to the center point, while the mobile telephone MT is operated from a safe position farther away from the fast-moving object O.

FIG. 2 illustrates a representative sound profile 200 which the mobile telephone's processor generates from the audio signal produced by the microphone MP during a velocity measurement. In the embodiment shown in FIG. 2, the sound profile 200 is generated by processing the sound as samples, one of which is denoted by reference numeral 202, and taking the sound intensity of each sample. Thus in a representative implementation the sound profile 200 is the sound intensity as a function of time.

As to the processing of “time” by the mobile terminal, any times discussed herein, such as the start time T1 or end time T2, need not be times on an absolute scale. In other words, the inventive program module being executed by the mobile terminal does not have to know the current time. It is rather the relative times that matter. In addition, the relative times need not be measured or expressed in seconds or milliseconds, and the times and time differences can be conveniently processed via sample numbers. Each sample has a sample length which is the inverse of the sampling rate.

Reference numeral 204 denotes some reference level, such as 0 dB, but the magnitude of the reference level is insignificant. Reference numeral 206 denotes a noise level such that for a significant proportion of time, the sound profile 200 remains below the noise level 206.

The portion of the sound profile 200 shown in FIG. 2 comprises two major peaks, generally denoted by reference numerals 210 and 212. The first peak 210 is caused by the start of the object's movement (traversal of span length). Depending on the nature of sport and object, the sound may be generated by the athlete kicking a ball, hitting a puck, letting go an arrow, or the like. The second peak 212 is caused by the object hitting a target, such as wall, fence or the like.

The inventive program module being executed by the mobile telephone's processor converts the presence of the peaks 210 and 212 to start and end times, respectively. Firstly, a specific moment of time should be associated with each peak. In one representative but non-restrictive implementation, the time associated with each peak 210, 212 is the time when the sound profile 200 exceeds a predetermined threshold 208 which is above the noise level 206. In the scenario shown in FIG. 2, the first peak 210 is detected by the crossing of the threshold 206 at time 216, while the second peak 212 is detected by the crossing of the threshold 206 at time 218.

In an alternative implementation, the start and end times 216, 218 can be determined based on the presence of the peaks' maximum values. In another alternative implementation, the start and end times 216, 218 can be determined based on times when the sound intensity increases by a predetermined step in a predetermined time window.

The notations 216 (≈T1) and 218 (≈T2) mean that the times denoted by reference numerals 216 and 218 no not precisely coincide with the start and end times T1, T2 of the object movement over the span length SL; rather the times 216 and 218 are the start and end times T1, T2 as measured by the mobile telephone MP under control of the inventive program module. For example, the times 216 and 218 lag the true start and end times T1, T2 at least by the propagation of sound from the start and end positions SS, SE over the distances d1, d2 to the microphone MP. Moreover, as stated above, the program module being executed in the mobile terminal need not know any of the times shown in FIG. 2 on any absolute scale; it is only the time differences between events that matter, and such time differences can be expressed in sample numbers.

Because the sounds generated at the start and end of the object movements have finite lengths, it is beneficial to employ sleep times 220, 222 such that crossing of the threshold 206 during the sleep time 220 is ignored. The sleep times 220, 222 also help suppress echoes from nearby objects. Reference numerals 214A and 214B denote two such echoes.

Based on the preceding description alone, the inventive program module cannot distinguish between the object movement's start time and end time. There are various ways to do so. In one implementation, each measurement event is triggered via the mobile telephone's user interface, for example by pressing a key. After the trigger, the first and second peaks which exceed the threshold 206 are considered the start and end of the object's movement, respectively. A problem with this somewhat crude approach is that the athlete or assistant must trigger each measurement event separately.

In a more user-friendly implementation a sliding time window is employed. After any period without detected sound intensity peaks, any detected peak 210 is assumed to correspond to the start time 216 of the object's movement. After that, any intensity development in the sleep time 220 is ignored and the next detected peak 212 is assumed to correspond to the end time 218 of the object's movement. However, a maximum time period 224 from the start time 216 is employed so as to be able to handle cases in which the end of the object movement goes undetected. For instance, the object may miss its intended target and thereby fail to produce a detectable sound. If the maximum time period 224 expires without the detection of the second peak 212 and end time 218, the previously-detected first peak 210 and start time 216 are ignored and the next peak to be detected will be processed as the first peak.

The time difference between the start time 216 and end time 218 may be used as the object's travel time TT. In an enhanced implementation the travel time TT may be corrected to compensate for unequal distances d1, d2 from the span start SS and span end SE to the microphone MP.

FIG. 3 is a schematic block diagram of a representative mobile terminal MT. The mobile terminal MT comprises a central processing unit CP 305 and memory 310. In addition, the mobile terminal MT comprises or utilizes external input-output circuitry 315 which constitutes the multimode terminal's user interface and comprises an input circuitry 320 and an output circuitry 325. The input circuitry 320 comprises the mobile terminal's microphone MP (see FIG. 1) and user-input device, such as a keypad and/or touch screen. The output circuitry 325 comprises the mobile terminal's display and earphone or loudspeaker (not shown separately). The mobile terminal MT further comprises or utilizes reception/transmission circuitry 330 which comprises a transmission circuitry 335, reception circuitry 340 and antenna 345. In order to support installable program modules, the mobile terminal's memory MEM comprises routines for downloading installable program modules and for storing the installable program modules in the memory MEM for execution by the central processing unit CP. FIG. 3 shows an arrangement in which the mobile terminal is configured to download installable program modules from a repository RP via a data network DN, an access network AN, the antenna 345 and reception circuitry 340, although other arrangements are equally possible, such as downloading the installable program modules via a short-range connection, such as Bluetooth or Universal Serial Bus (USB, not shown separately). At this level of generalization, all previously-discussed elements of FIG. 3 can be conventional as used in the relevant art.

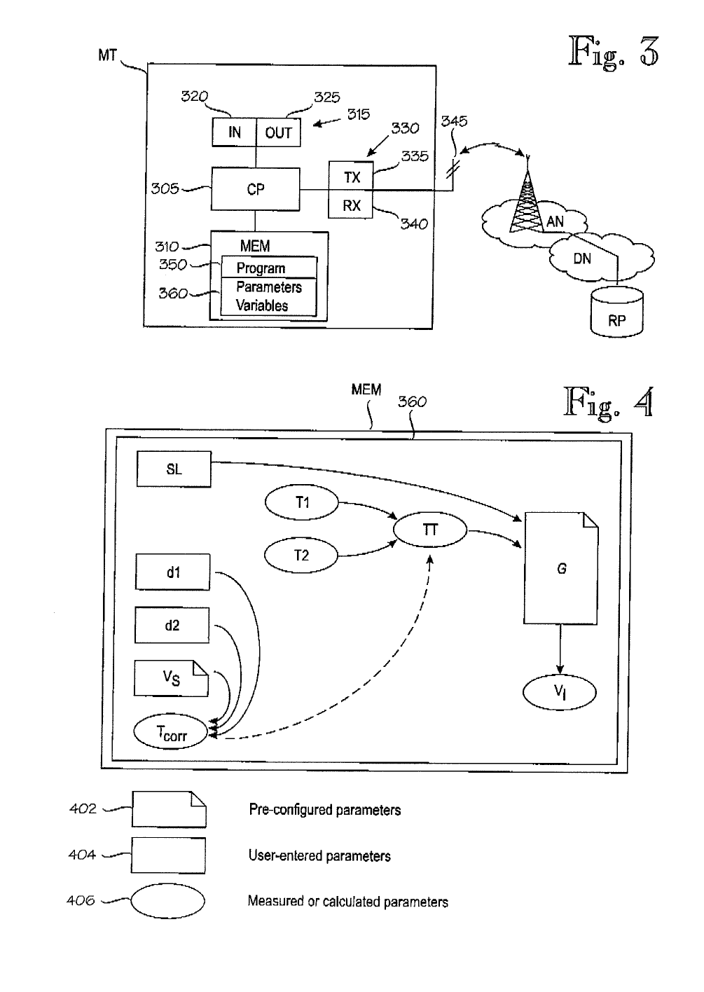

In order to solve the problems underlying the present invention, the mobile terminal's memory MEM is provided with a program module 350 which performs the required measurements and calculations. The program module 350 uses the mobile terminal's memory MEM for storing parameters and variables, collectively denoted by reference numeral 360. Their significance will be described in connection with FIG. 4.

FIG. 4 shows some of the data structures, parameters and variables in the memory MEM of the mobile telephone MT according to an embodiment of the invention. Symbols 402 represent pre-configured parameters which can be set up by the programmer of the program module 350. The pre-configured parameters represented by symbols 402 need not be fixed; rather the programmer may set an initial value for them and the mobile terminal user may later fine-tune them, Symbols 404 represent user-entered parameters while symbols 406 represent parameters measured or calculated by the mobile terminal under control of the program 350.

In a simple implementation, the only user-entered parameter is the span length SL, ie the span from the object's initial position to the target. The program 350 detects the sound peaks corresponding to the start time T1 and end time T2 of the object's movement over the span length. As stated earlier, in connection with FIG. 2, it is not necessary to determine the times T1, T2 on any absolute scale, so long as the sound peaks are detected and the duration between them in any explicit or implicit units of time, such as milliseconds or sample periods. Based on the time difference T2−T1 the program 350 determines the object's travel time TT over the span length SL.

In an enhanced implementation the program 350 may query the user for the distances d1, d2 from the span start SS and span end SE to the microphone MP. Alternatively the program 350 may query the user for the difference d2−d1. The difference d2−d1 divided by the speed of sound V_{S} yields a time correction T_{corr} which can be subtracted from the difference T2−T1 to obtain a more accurate value for the object's travel time TT.

The span length SL and the travel time TT are applied to a function, routine or lookup table denoted by G. In the following description, the term “function” will mean any data structure which accepts at least one input value and outputs at least one predetermined output value based on the at least one input value. Accordingly, the element G this element will be called function G although, in terms of programming, it can be implemented as calculation (sub)routine, lookup table or any comparable data structure. The input values for the function G include the span length SL and the travel time TT, and the output values include the object's velocity. In the implementation shown in FIG. 4, the reference sign V_{I} denotes the object's initial velocity. The initial velocity V_{I} can be calculated by calculating the object's average velocity SL/TT and applying an appropriate correction. As stated earlier, such a correction can be determined empirically, for example by performing a statistically sufficient number of experiments in which the object's average velocity is determined by dividing the span length traversed by the object by the travel time, while the object's initial velocity is determined with some other means, such as Doppler radar. Such a statistically sufficient number of experiments will yield an empirical correction by which the initial velocity can be determined on the basis of average velocity and/or its underlying parameters span length SL and travel time TT. Alternatively, it is possible to model the object's flight by conventional physics and calculate appropriate corrections for determining the initial velocity on the basis of the average velocity. The two most important factor for such physical modelling are the object's air resistance and weight, as these determine the object's deceleration rate.

Regardless of whether the correction from average velocity to initial velocity is determined empirically or by physical modelling, it is also possible to implement the program 350 such that it entirely bypasses the determination of the average velocity and employs such an empirically-determined or physically-modelled function G whose inputs are the span length SL and travel time TT and the output of the function is the initial velocity V_{I}.

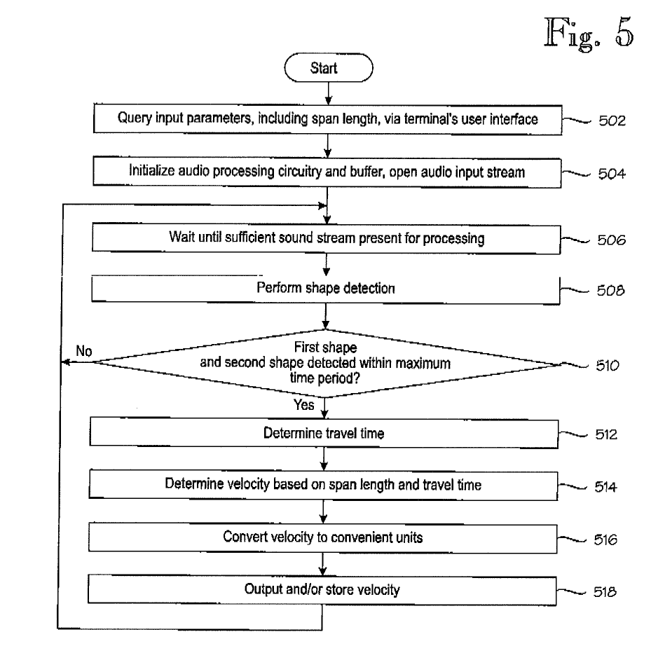

FIG. 5 illustrates an operating principle of the invention. All acts shown in FIG. 5 are performed by the mobile terminal MT under control of the inventive program module 350. In step 502 the program module 350 causes the mobile terminal to query the input parameters, including at least the span length SL, via the terminal's user interface. For instance, the user may be prompted to key in the span length. In addition, the user may be prompted to enter the distances d1, d2 from the span start SS and span end SE to the microphone MP, or only the difference d2−d1. In a slightly simpler implementation, the user may be prompted to select one of several options, which may indicate whether the microphone is close to the span start, span end or equidistant from them. In step 504 the program module 350 causes the mobile terminal to initialize its audio processing circuitry and buffer, and to open an audio input stream. Steps 502 and 504 are initialization steps that need not be repeated for each measurement. In step 506 the mobile terminal waits until the buffer holds sufficient audio stream data for processing. After that, in step 508 the mobile terminal, under control of the program 350, performs a shape detection function on the buffered (and sampled) audio stream. As stated in connection with FIG. 2, the shapes to be detected may comprise crossing of a predetermined sound intensity level, a sharp rise in intensity (sufficient slope and magnitude), or the like. Step 510 comprises a check as to whether the first shape and second shape are detected within the maximum time period. If not, either the start or end of the object's traversal has gone undetected and the process returns to step 506. If the first shape and second shape are properly detected, the objects' travel time TT is determined in step 512. Step 514 comprises determining the object's velocity on the basis of span length SL and travel time TT, Various corrections may be performed, as stated in connection with FIG. 4. In step 516 the determined velocity is converted to convenient units. For example, the audio processing under control of the program module 350 may use a sample duration (inverse of sampling rate) as a unit of time, and the sample duration should be converted to seconds for a more user-friendly output. In addition, the user may be prompted to enter the span length in metres or feet, while the program module 350 may be configured to output the velocity in kilometres or miles per hour. In step 518 velocity is outputted and/or stored in the mobile terminal's memory.

In order to eliminate a need for the mobile terminal user to read the determined object velocity for each attempt, the mobile terminal may maintain a top-n list of velocities, wherein “n” stands for some convenient number of best scores, such as a number from 1 to 20. The top-n list may be maintained separately for each sport and user. In case the object velocity just determined exceeds the previous record, the mobile terminal may produce some audible and/or visible alert, such as a recognizable tone or flashing of its display. The user may be given an opportunity to accept or reject the new record or a new entry into the top-n list. For instance, new records or top-n entries may be rejected in situations wherein a spurious sound has been detected as one of the shapes 210, 212 corresponding to the start and end times T1, T2 of the object's traversal of the span length SL. Alternatively, the new records or top-n entries may be rejected in situations wherein some of the operating parameters have been entered incorrectly.

The flow chart shown in FIG. 5 looks like an endless loop, but in practice the loop may be terminated via system functions provided by the mobile terminal's operating system, for example in response to detection of a pressed “stop” key in the mobile terminal's keypad.

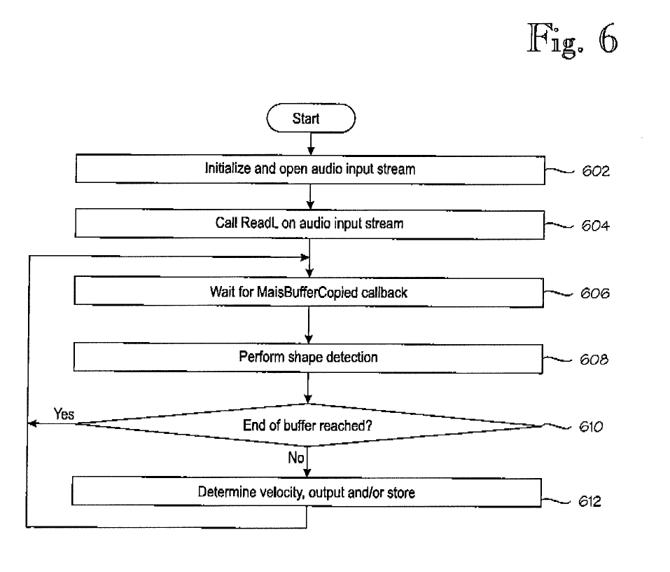

FIG. 6 is a flowchart which illustrates an embodiment specifically adapted for Symbian-based platforms. Step 602 comprises initializing an audio input stream and opening it. Symbian class CMdaAudioInputStream can be used for this purpose. The initialization comprises setting up a buffer for the audio input stream. Step 604 comprises calling ReadL function on the audio input stream. Step 606 comprises waiting for MaiscBufferCopied callback function (that follows calling ReadL function of CmdaAudioInputStream). This callback function indicates that the audio input buffer holds sufficient data for processing. Step 608 comprises performing shape detection, which can be performed similarly to step 508 of FIG. 5. Step 610 comprises checking whether the end of the audio input buffer was reached in the shape detection process. Reaching the end of the audio input buffer was reached means that either the first shape 210 or second shape 212 (see FIG. 2) was not properly detected, in which case the process returns to step 606. If the shape-detection process was completed without reaching the end of the audio input buffer, this means that the first shape 210 and second shape 212 were properly detected, in which case the process continues to step 612, in which the velocity is determined and the determined velocity is outputted and/or stored. Step 612 of FIG. 6 corresponds to steps 512 through 518 of FIG. 5.

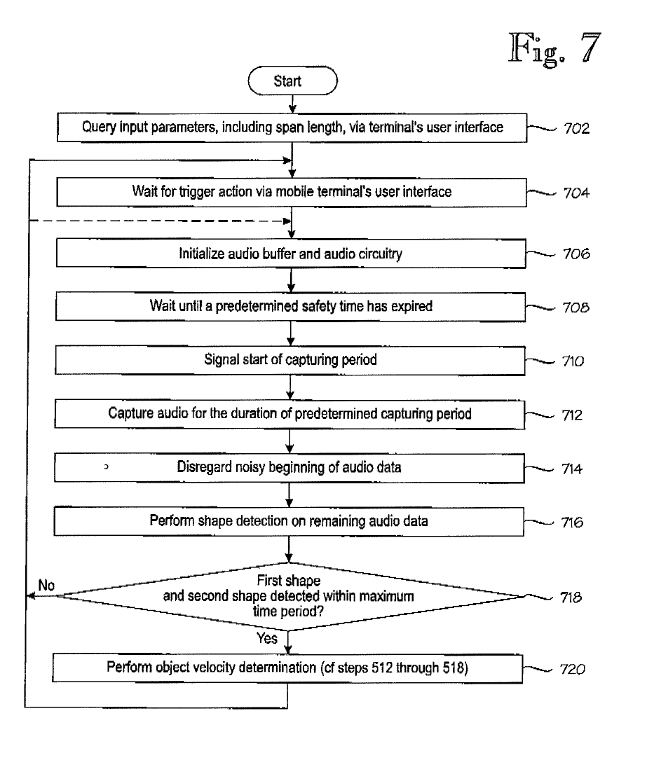

FIG. 7 is a flowchart which illustrates an embodiment specifically adapted for Java-based platforms. The generic flowchart shown in FIG. 5 may not be readily realizable on mobile terminals having low-power microprocessors. A residual problem in connection with such mobile terminals is that the low-power microprocessors lack sufficient processing power to perform the shape-detection process (see FIG. 2 and steps 506 and 508 in FIG. 5) in real time. The flowchart shown in FIG. 7 solves that residual problem by merely capturing audio samples in real time for a predetermined period of time, and performing the shape detection on the audio samples after the capturing process. The flowchart of FIG. 7 can be implemented by installing an appropriate Java applet (or “midlet”) into the mobile terminal's memory.

The flowchart for Java-based platforms, as shown in FIG. 7, shares several steps with the flowchart shown and described in connection with FIG. 5, and such steps will not be described again. Specifically, steps 502 to 508 of the flowchart of FIG. 5 are replaced by steps 702 through 716, after which the process is similar to the one defined by steps 510 through 518 of FIG. 5. The flowchart begins with a parameter-querying step 702, which is similar to step 502 and will not be described again. In step 704, the mobile terminal, under control of the Java applet, waits for some trigger action via the mobile terminal's user interface. For example, the trigger action may be a key press or the utterance of sound exceeding a predetermined intensity threshold. In step 706 the mobile terminal initializes its audio buffer and audio processing circuitry. The trigger action also triggers a short wait period, step 708, during which the user can move to a safe distance from the mobile terminal. This is useful in situations wherein the mobile terminal is left to monitor a hard, heavy or fast object, such as a tennis ball or ice hockey puck. After the expiry of the safe time, the mobile terminal signals the start of the audio capturing period in step 710. For example, the mobile terminal may output a sound and/or flash a light on its display, to indicate the start of the audio capturing period. In step 712 the mobile terminal captures audio data for the duration of a predetermined capturing period.

As stated earlier, the application programming interface (API) of mobile terminals may not offer programming functions for measuring time with sufficient accuracy. Accordingly, time-related quantities, such as the length of the audio capturing period, may be determined indirectly. For instance, the inventive Java applet may direct the mobile terminal's processor to capture a predetermined number of audio samples. Alternatively, an appropriate maximum length may be assigned to the capture buffer, wherein the maximum length may be defined as the number of audio samples that the capture buffer can hold. An overflow condition of the capture buffer may then indicate of the expiry of the audio capturing period.

Execution of step 714 involves an operation which solves another residual problem of typical mobile terminals, namely the fact that the beginning of the capture buffer, ie, a few first audio samples, are frequently noisy. This phenomenon may be caused by a finite settling time of the various components of the audio processing circuitry. For instance, if automatic gain control (AGC) is being utilized, the AGC circuitry may need some time to settle. Accordingly, the noisy beginning of the audio capture buffer should be ignored and the shape detection operation in step 716 should only be performed on the relatively noiseless part of the audio capture buffer. In one implementation, the Java applet may automatically determine an appropriate length of time (number of audio samples) that should be ignored, by requesting the user of the mobile terminal to place the mobile terminal into a quiet location, after which the Java applet captures that relative silence and detects the number of noisy audio samples in the beginning of the buffer. As this is a terminal-specific calibration operation, it only has to be performed once for each terminal (or terminal type) and stored as one of the operating parameters (see item 360 in FIG. 3). The shape detection process in step 716 is very similar to the one described in connection with FIG. 5 (step 508), and a detailed description is omitted. There are two differences between step 716 of FIG. 7 and step 508 of FIG. 5. One difference is that the shape-detection operation of step 716 is performed on a captured and buffered (temporarily stored) set of audio samples, while the operation of step 508 is performed on a real-time audio stream. This means that, at least in theory, the process described in connection with FIG. 5 can wait indefinitely for the first shape (item 210 in FIG. 2) that corresponds to the start of the object's movement, and the detection of the second shape (item 212) can trigger the termination of the capturing process. In contrast, the process described in connection with FIG. 7 must capture audio samples for the whole length of the capture buffer and only afterwards search the capture buffer for the occurrence of the first and second shapes 210, 212 that respectively correspond to the start and end times T1, T2, of the object's traversal of the span length SL. The other difference between the shape-detection operations of FIGS. 5 and 7 is that step 716 of FIG. 716 should disregard the noisy beginning of the capture buffer.

FIG. 7 shows a partial flowchart because after step 716, the process can be continued similarly to the process shown in FIG. 5, such that step 716 is followed by a test 718 and a velocity-determination process 720, he test 718 may be similar to the test 510 described in connection with FIG. 5, while the velocity-determination process 720 may be similar to the sequence of steps 512 through 518. For a detailed description of these steps, a reference is made to the description of the corresponding steps in FIG. 5.

FIG. 7 shows a version of the flowchart in which each velocity-determination process is followed by a return to step 704 in which the mobile terminal waits for a separate trigger action via the mobile terminal's user interface. Alternatively, the return can be made to step 706, as indicated by the dashed line immediately above step 706. In this case the inventive applet causes the mobile terminal to operate in a continuous mode in which each velocity-determination process is automatically followed by the next, without any explicit trigger action via the user interface. The choice between the single action mode (return to step 704) or continuous action mode (return to step 706) can be requested via the mobile terminal's user interface as part of step 702.

It is readily apparent to a person skilled in the art that, as the technology advances, the inventive concept can be implemented in various ways. The invention and its embodiments are not limited to the examples described above but may vary within the scope of the claims

We claim:

1. A method for determining a velocity of an object, comprising:
receiving an audio signal by a microphone operatively coupled to a mobile telephone;
determining a span length to be traversed by the object, wherein the span length extends from a span start to a span end;
determining an approximate travel time for a traversal of the span length from the span start to the span end by the object, wherein the determination of the approximate travel time comprises:
processing the audio signal and detecting a first shape and a second shape which respectively correspond to an approximate start time and approximate end time of the traversal;
determining the approximate travel time based on the detected first shape and second shape;
determining the velocity of the object based on the span length and approximate travel time; and
outputting the velocity of the object to a physical output device.

2. A method according to claim 1, wherein the determination of the velocity comprises determining an average velocity and applying a correction to the average velocity to determine an initial velocity.

3. A method according to claim 1, wherein the determination of the velocity comprises determining an initial velocity by applying the span length and travel time to a function or lookup table.

4. A method according to claim 1, wherein the determination of the travel time comprises compensating for unequal distances of the microphone from the span start and span end.

5. A method according to claim 1, wherein the detection of the first shape and/or second shape comprises processing the received audio signal as audio samples each of which has an intensity, and detecting:
a sample whose intensity exceeds a predetermined threshold; or
a group of consecutive samples wherein the group's last sample has an intensity which exceeds the intensity of the group's first sample by a predetermined margin.

6. A method according to claim 5, wherein said determining of the velocity of the object is performed as a real-time operation.

7. A method according to claim 5, wherein said determining of the velocity of the object comprises capturing and buffering the audio samples prior to said detecting.

8. A method according to claim 5, wherein the determination of the approximate travel time comprises determining the number and duration of samples between the detected first shape and second shape.

9. A method according to claim 5, further comprising skipping a predetermined number of samples or milliseconds after the detected first shape and/or second shape before detecting a subsequent shape.

10. A mobile telephone, comprising:
means for receiving an audio signal by a microphone operatively coupled to a mobile telephone;
means for determining a span length to be traversed by the object, wherein the span length extends from a span start to a span end;
means for determining an approximate travel time for a traversal of the span length from the span start to the span end by the object, wherein the means for determining the approximate travel time comprises:
means for processing the audio signal and detecting a first shape and a second shape which respectively correspond to an approximate start time and approximate end time of the traversal;
means for determining the approximate travel time based on the detected first shape and second shape;
means for determining the velocity of the object based on the span length and approximate travel time; and
means for outputting the velocity of the object to a physical output device.

11. A software program product, executable in a mobile telephone, wherein execution of the software program product in the mobile telephone causes the mobile telephone to carry out the steps of claim 1.
